(19) United States
(12) Patent Application Publication
(10) Pub. No.: US 2015/0016054 A1
(43) Pub. Date: Jan. 15, 2015

(54) Notebook Auxiliary Device

(71) Applicant: Wei Yin Tsai, Tainan City (TW)

(72) Inventor: Wei Yin Tsai, Tainan (TW)

(21) Appl. No.: 14/329,008

(22) Filed: Jul. 11, 2014

(30) Foreign Application Priority Data
Jul. 11, 2013 (TW) 102213156

(51) Int. Cl. G06F 1/20; F16M 11/00; G06F 1/16

(52) U.S. Cl. CPC G06F 1/203; G06F 1/1675; F16M 11/00
USPC 361/679.46; 361/679.55; 248/676

(57) ABSTRACT

A notebook auxiliary device includes a first rigid body, a second rigid body and a folding portion. The first rigid body is disposed on a top surface of a screen body of a notebook. The second rigid body is disposed on a bottom surface of a mainframe body of the notebook. A folding portion is disposed between the first rigid body and the second rigid body, and the folding portion is driven by the first rigid body such that the folding portion is bent under the mainframe body to produce a protrusion so as to form a preset support angle to support the mainframe body. Thus, one side of the notebook can lift to a preset support angle when the notebook is at open state, so as to increase the heat dissipation effect of the notebook and to reduce the fatigue which is introduced by prolonged use of notebook.

### FIELD OF THE INVENTION

The present invention relates to a notebook auxiliary device, and more particularly to a notebook auxiliary device with stopping function.

### BACKGROUND

In modern life, the notebook is an indispensable electronic product for many people. The notebook is composed by connecting a screen body and a mainframe body, and the notebook equipped with the portable function for replacing the application of the personal computer whether the notebook can carry out in the office or entertainment, and the convenience in practical indeed bring the considerable for the human civilization.

Of cause, the notebook is similar to other electronic device, the notebook brand style is dazzling, and one of the most loved by the people is a high portability and high endurance ultra-thin notebooks (Ultra-book). The ultra-thin notebooks abandon the traditional drives which are configured, and some non-essential slots, the notebook utilizes flash memory or solid state drive (SSD) to replace the traditional hard disk drive (HDD), so that the required space of the hard disk can be saver, and allowing for the ultimate in lightweight and volume.

However, the different from the traditional notebook, in order to make ultra-thin notebooks to thinner, the rotatable pivot on the top surface of the mainframe body is removed to dispose on one side of the mainframe body, such that the required space of the rotatable pivot can be reduced. Thus, in order to match the arrangement of the rotatable pivot of the ultra-thin notebook, the heat dissipation hole on one side of the mainframe body is to be omitted, such that the heat dissipation of the ultra-thin notebook is exhausted from the other heat dissipation holes on the bottom surface of the mainframe body. However, user always puts the ultra-thin notebook on the desk, so that the heat dissipation hole on the bottom surface of the mainframe body is blocked off by the surface of the desk so that the heat cannot be exhausted from the heat dissipation hole to the outside of notebook, and thus the heat dissipation effect of the ultra-thin notebook is to be reduced.

Therefore, whether there is a notebook auxiliary devices can enable the heat dissipation hole of the ultra-thin notebooks which have enough space to perform air convection for exhausting heat, and also matches the ergonomic which tilts ultra-thin notebooks to the most appropriate angle for the user's perspective, it not only can reduce user fatigue, and more able to enhance the heat dissipation effect of the ultra-thin notebook.

### SOME EXEMPLARY EMBODIMENTS

It is one object of this invention is to provide a notebook auxiliary device equipped with a stopping function.

According to above-mention, the present invention provides a notebook auxiliary device, which includes a first rigid body, a second rigid body and a folding portion. The first rigid body is disposed on a top surface of a screen body of a notebook. The second rigid body is disposed on a bottom surface of a mainframe body of the notebook. A folding portion is disposed between the first rigid body and the second rigid body, the folding portion is driven by the first rigid body such that the folding portion is bent under the mainframe body to produce a protrusion so as to form a preset support angle to support the mainframe body.

The present invention also provides a notebook auxiliary device which is composed a sheet with a three-layers structure, and the notebook auxiliary device includes a first outer layer, a support layer and a second outer layer. The support layer covered one surface of the first outer layer and the support layer also includes a first trench, a second trench and a bending line. The first trench is formed on one side of the support layer. The second trench is formed on another side of the support layer and is paralleled to the first trench. The bending line is disposed and paralleled between the first trench and the second trench.

Therefore, to compare with the present notebook auxiliary device, the notebook auxiliary device of the present invention can fix on outside of the notebook by the first rigid body and the second rigid body. When the notebook is at open state, one side of the notebook is lifted by the folding portion to a preset support angle, such that users can utilize notebook in a comfortable position, and in a more ergonomic way to reduce fatigue which is introduced by prolonged use of notebook. Because of the preset support angle is disposed between the notebook and the desk, such that the thermal conversion space of the notebook can be increased and good heat dissipation effect can be obtained. In addition, because of the notebook auxiliary device of the present invention is disposed on the outside of the notebook such that user can grip the notebook and is not fallen from the hand of the user, such that notebook auxiliary device can protect the notebook shell and the proportion of goods damaged can also be reduced.

Other objects, advantages and salient features of the invention will become apparent from the following detailed description taken in conjunction with the annexed drawings, which disclosed preferred embodiments of the invention.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a solid view of showing a notebook equipped with notebook auxiliary device of one embodiment in accordance with the present invention disclosed herein;

FIG. 1B is a solid view of showing one embodiment of a notebook auxiliary device equipped with heat dissipation hole which arranged on the notebook therein in accordance with the present invention disclosed herein;

FIG. 2A is a solid view of showing a notebook auxiliary device in accordance with the present invention disclosed herein;

FIG. 2B is a solid view of showing a notebook auxiliary device equipped with heat dissipation hole therein in accordance with the present invention disclosed herein;

FIG. 3 is a schematic view of showing a notebook auxiliary device arranged on the notebook at open state in accordance with the present invention disclosed herein;

FIG. 4A is a schematic view of showing a notebook auxiliary device arranged on the notebook at open state in accordance with the present invention disclosed herein;

FIG. 4B is portion enlarged schematic view of FIG. 4A for showing a notebook auxiliary device arranged on the notebook at open state in accordance with the present invention disclosed herein;

FIG. 5A is a solid view of showing another embodiment of notebook equipped with the notebook auxiliary device in accordance with the present invention disclosed herein;

FIG. 5B is a solid view of showing another embodiment of notebook auxiliary device equipped heat dissipation hole which arranged on the notebook in accordance with the present invention disclosed herein;

FIG. 6 is a cross-sectional view of showing one embodiment of a notebook auxiliary device in accordance with the present invention disclosed herein; and

FIG. 7 is a solid view of showing another embodiment of the notebook auxiliary device in accordance with the present invention disclosed herein.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

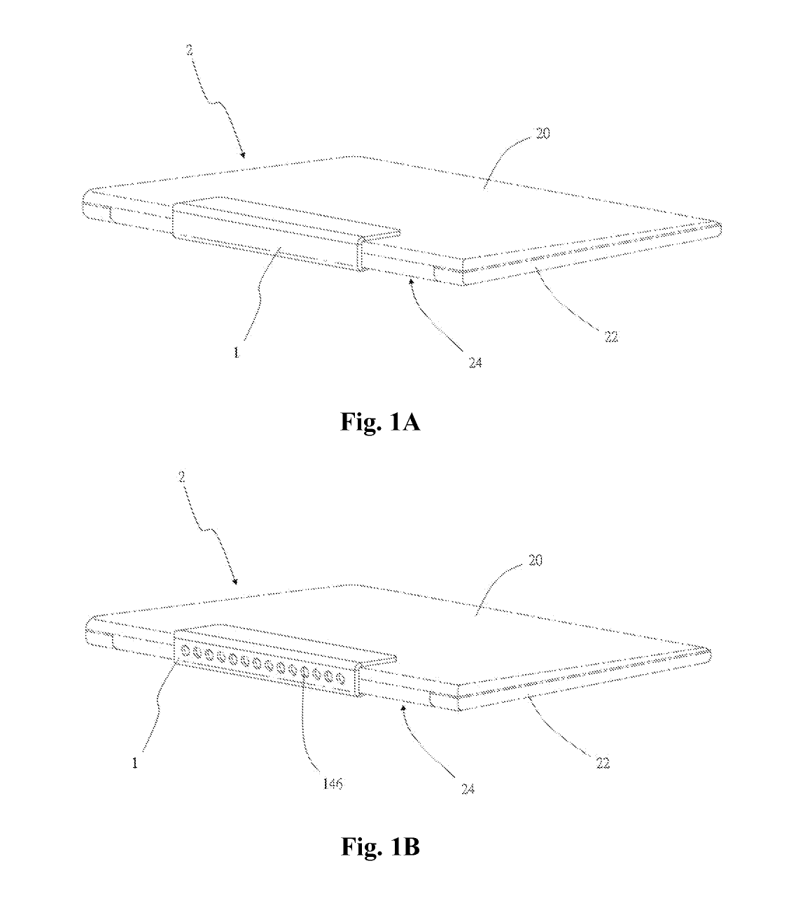

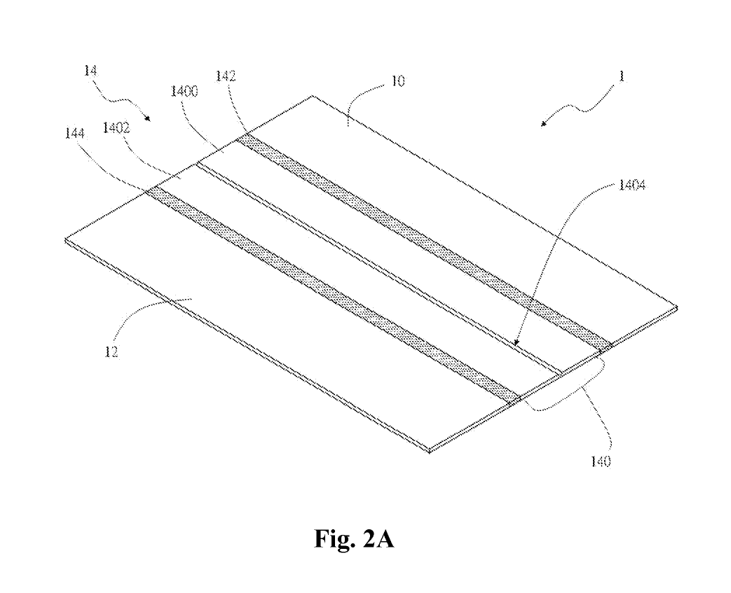

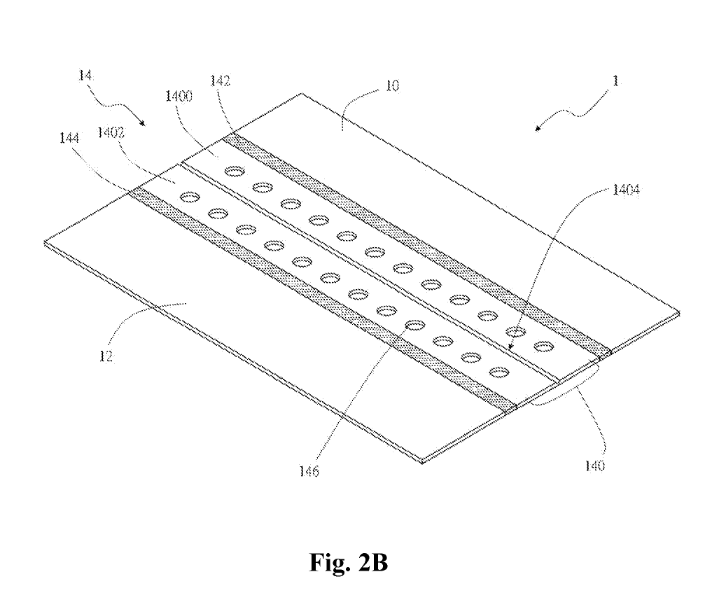

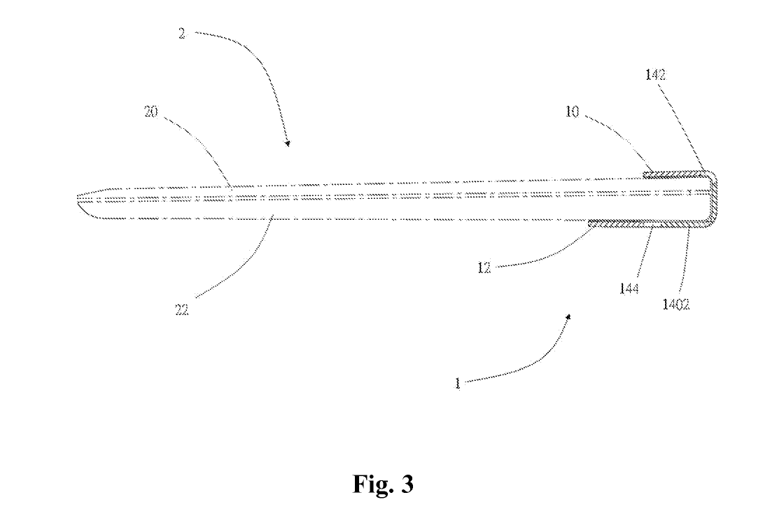

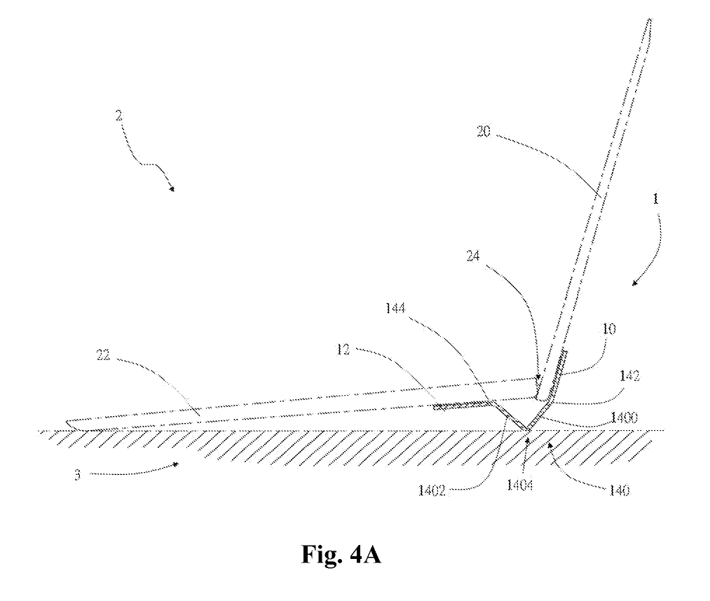

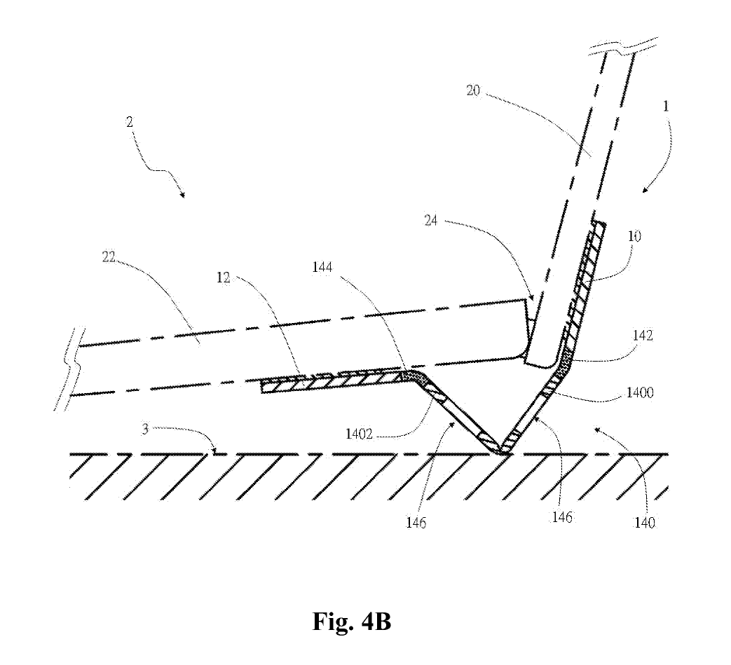

Please refer to FIG. 1A to FIG. 4B. FIG. 1A is a solid schematic which representations a notebook equipped with the notebook auxiliary device. FIG. 1B is a solid schematic which representations a notebook auxiliary device equipped with a heat dissipation hole therein which disposed in the notebook. FIG. 2A is a solid schematic which representations a notebook auxiliary device. FIG. 2B is a solid schematic which representations a notebook auxiliary device equipped with heat dissipation hole therein. FIG. 3 is a schematic view of showing the notebook equipped with notebook auxiliary when notebook is at close state. FIG. 4A is a schematic view of showing a notebook equipped with notebook auxiliary device when the notebook is at open state. FIG. 4B is portion enlarged schematic view of FIG. 4A for showing a notebook auxiliary device arranged on the notebook at open state in accordance with the present invention.

In an embodiment, the notebook auxiliary device 1 of the present invention disposed on a notebook 2 which is also called ultra-thin notebook (or called Ultra-book). Generally, the notebook 2 includes a screen body 20 and a mainframe body 22. The screen body 20 is connected to the mainframe body 22 by a rotatable pivot 24. That is, one side of the notebook 2 is an engaged side which is disposed between the screen body 20 and the mainframe body 22, and another side of the notebook 2 is disposed on an open side which is between the screen body 20 and the mainframe body 22. When the screen body 20 is overlapped the mainframe body 22, the location of the notebook is at close state. In other words, when the screen body 20 is rotated at a preset support angle corresponding to the mainframe body 22, the location of notebook 2 is at open position. In addition, the notebook 2 can open or close between the close state and open state.

As shown, the notebook auxiliary device 1 of the present invention includes a first rigid body 10, a second rigid body 12 and a folding portion 14, in which the first rigid body 10 is disposed on a top surface of the screen body 20 of the notebook 2, the second rigid body 12 is disposed on the bottom surface of the mainframe body 22 of the notebook 2 and the folding portion 14 is disposed between the first rigid body 10 and the second rigid body 12, and a rotatable pivot 24 covered the portion of the notebook 2. When the notebook 2 is at close state, the folding portion is bent on one side of the rotatable pivot 24 of the notebook 2.

It is note that when the notebook 2 from close state to open state, the screen body 20 is rotated corresponding to the mainframe body 22 so that the first rigid body 10 drives the folding portion 14 to bend under the bottom surface of the mainframe body 22 to produce a protrusion (as shown in FIG. 4A an FIG. 4B).

The shape of the protrusion is triangular protrusion or a square-shaped protrusion. When the user puts the notebook 2 on a desk 3, the protrusion stops the rotatable pivot 24 of the notebook 2 and stops between the notebook 2 and the desk 3, such that a preset support angle is between the mainframe body 22 of the notebook 2 and the desk 3. Thus, the heat dissipation effect of the notebook 2 can be increased, and user can use notebook in comfortable and safer.

For example, when user utilizes the notebook 2 equipped with the notebook auxiliary device 1, when the notebook 2 is at open state, the user will put the hands on an inside surface corresponding to the mainframe body 22, and the preset support angle between the arms and the desk 3 will approach the preset support angle, such that the hands and arms are in a straight line and is not to be bent in a direction. Thus, the user can achieve more ease of use and comfort typing.

Furthermore, the folding portion 14 further includes a rigid region 140, a first softness body 142 and a second softness body 144. The rigid region 140 is composed by connecting the third rigid body 1400 and a fourth rigid body 1402. A bending line 1404 is disposed between the third rigid body 1400 and the fourth rigid body 1402. The third rigid body 1400 can bend toward one direction corresponding to the fourth rigid body 1402 according to the bending line 1404. The first softness body 142 connects between the first rigid body 10 and the third rigid body 1400, and the first rigid body 10 can rotate and bend in a direction corresponding to the third rigid body 1400. The second softness body 144 connects the fourth rigid body 1402 and the second rigid body 12, and the second rigid body 12 can rotate and bend in a direction corresponding to the fourth rigid body 1402.

The folding portion 14 further includes at least a heat dissipation hole 146. Each heat dissipation holes 146 are arranged with a spacing and is formed in the third rigid body 1400 and the fourth rigid body 1402, such that the heat dissipation efficiency can be achieved (as shown in FIG. 1B, FIG. 2B and FIG. 4B). In addition, the first rigid body 10, the second rigid body 12, the third rigid body 1400 and the fourth rigid body 1402 can be a metal material, such as metal sheet, which is equipped with the support effect. The first softness body 142 and the second softness body 144 can a flexible cotton material such as sliver or a the rubber material such as rubber strip with reciprocating deformable. Moreover, a hollow groove is formed between each rigid body by the first softness body 142 and the second softness body 144 respectively, the hollow groove is used to enable each rigid body has a reserved space therebetween, in order to facilitate the rotation or folding of each rigid body.

That is, the notebook auxiliary device 1 of the present invention is bent by the rotation between the third rigid body 1400 and the fourth rigid body 1402, and the first rigid body 10 is bent corresponding to the third rigid body or the third rigid body 1400 is bent corresponding to the first rigid body 12 toward a direction by using a first softness body 142. In addition, the second rigid body 12 is bent corresponding to the fourth rigid body 1402 or the fourth rigid body 1402 is bent corresponding to the second rigid body 12 toward a direction by using the second softness body 144. Further, the arrangement of each heat dissipation holes is used to increase the heat dissipation effect.

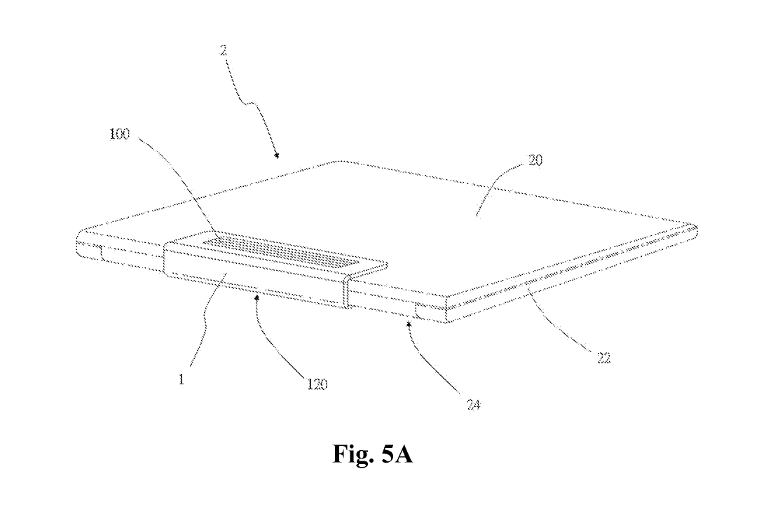

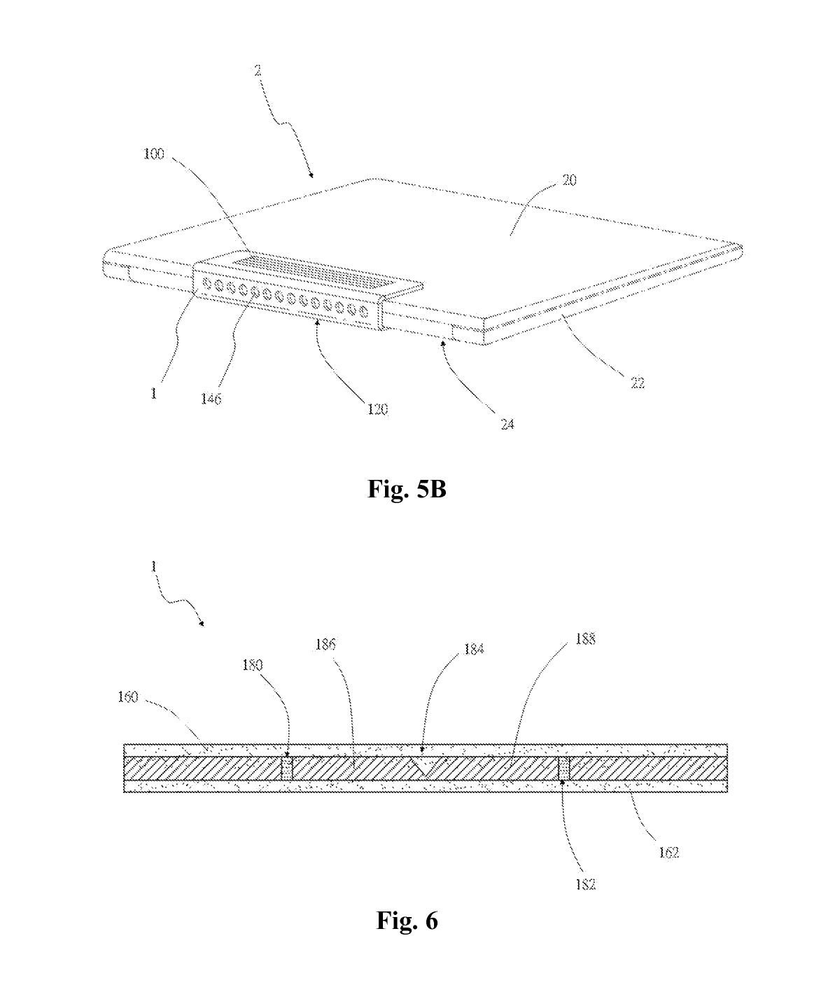

Please refer to FIG. 5A and FIG. 5B. FIG. 5A is a solid view of showing a notebook auxiliary device which arranged in the notebook. FIG. 5B is a solid view of showing an embodiment of a notebook auxiliary device equipped with heat dissipation hole which arranged in the notebook of the present invention. In general, because the ultra-thin notebook is light and thin but is difficult to grip, and the tightly structure of the ultra-thin notebook will reduce some buffer space at impact, so that the ultra-light notebook will be damaged due to the notebook falls down easily from the user.

In order to reduce the damage of the notebook by falling down from the user, in one embodiment of the present invention, the notebook auxiliary device 1 further includes a first slip resistant 100 and a second slip resistant 120. The first slip resistant 100 is disposed outside of the screen body 20 and the second slip resistant 120 is disposed outside of the second rigid body 12 corresponding to the mainframe body 22, in which the first slip resistant 100 and the second slip resistant 120 are disposed on one side of the rotatable pivot 24 near the notebook 2. In addition, the first slip resistant 100 and the second slip resistant 120 are elastic material with higher friction and soft touch to increase the friction on the outside of the notebook auxiliary device 1, so as to the grasp stability can be increased.

For example, when the user picks up the notebook 2 equipped with the notebook auxiliary device 1, user can grip the notebook 2 on the connection portion between the screen body 20 and the mainframe body 20 of the notebook 2. The user's finger grips the first slip resistant 100 and the second slip resistant 120 of the present invention, and the first slip resistant 100 and the second slip resistant 120 can prevent the notebook 2 slipping out from the user. Thus, when the user picks up the notebook 2 equipped with the notebook auxiliary device 1 and the user will have “holding” realism.

Please refer to FIG. 6. FIG. 6 is a cross-sectional view of the notebook auxiliary device of one embodiment of the present invention. In one embodiment, the notebook 1 is composed of a sheet with three-layers structure. The notebook auxiliary device 1 includes a first outer layer 160, a support layer 18 and an second outer layer 162, in which the support layer 18 is disposed and covered on a surface of the first outer layer 160 and the second outer layer 162 is disposed on another surface of the support layer 18 corresponding to the first outer layer 160. That is, the first outer layer 160, the support layer 18 and the second outer layer 162 are arranged in sequence. In addition, the material of the first outer layer 160 and the second outer layer 162 can be soft cotton material or reciprocally deformable rubber material, in which the support layer further includes a first trench 180, a second trench 182 and a bending line 184.

The first trench 180 is formed on one side of the support layer 18, the second trench 182 is formed on one side of the support layer 18 respect to the first trench 180, and the second trench 182 is paralleled the first trench 180. The bending line 184 is paralleled and disposed between the first trench 180 and the second trench 182, and a first interval section 186 is disposed between the bending line 184 and the first trench 180, and a second interval section 186 is disposed between the bending line 184 and the second trench 182. That is, the first trench 180, the bending line 184 and the second trench 182 are arranged on the support layer in sequence, such that the support layer 18 can bend from the first trench 180, the bending line 184 and the second trench 182 in a direction.

As aforementioned, the notebook 2 equipped with notebook auxiliary device 1, and the first trench 180 can be regard as the first softness body 142, the first interval section 186 can be regard as the third softness body 1400, the second interval section 188 can be regard as the fourth interval section 1402, and the second trench 182 can be regard a the second softness body 144, that is, the first trench 18, the first interval section 186, the bending line 184, the second interval section 188 and the second trench 182 is the folding portion 14 as the aforementioned, the combination of the first interval section 186 and the second interval section 188 is a rigid region 140 of the folding portion 14. Similar, the first interval section 186 and the second interval section 188 includes the heat dissipation hole 146 as aforementioned. Each heat dissipation hole 146 is arranged in a sequence and is formed on one side of the first interval section 186 or the second interval section 188, or is formed on the one side of the first interval section 186 and the second interval section 188 to increase the heat dissipation effect.

The interval between the first trench 180 and the bending line 184 is the size of the first interval section 180, such size is corresponding to the thickness of the notebook 2. In general, the thickness of the notebook 2 indicates that the notebook 2 is placed in a horizontal level. When the screen body 20 is overlapped the mainframe body 22, the height of the notebook 2 is higher than the horizontal level. In this embodiment, in order to the first interval section 186 covered the one side of the rotatable pivot 24 of the notebook 2, and the interval between the first trench 180 and the bending line 184 is identical to the thickness of the notebook 2.

Furthermore, for forming the protrusion in aforementioned embodiment, the interval between the bending line 184 and the second trench 182 indicates the size of the second interval section 188 which depends upon the size of the first interval section 186 to match the first interval section 186 with the appropriate preset support angle for supporting the notebook 2.

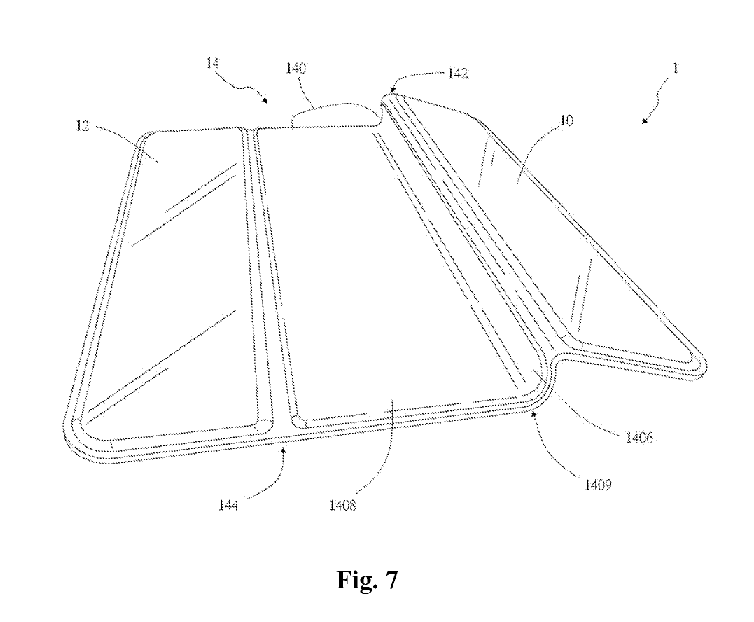

Please refer to FIG. 2A and FIG. 7. FIG. 7 is a solid view of showing the notebook auxiliary device of the present invention. As shown in FIG. 2A and FIG. 7, the notebook auxiliary device of this embodiment as similar as described aforementioned, the notebook auxiliary device 1 includes a first rigid body 10, a second rigid body 12 and a folding portion 14. The folding portion 14 includes a rigid region 140, the first softness body 142 and a second softness body 144. It is note that the rigid region 140 of the folding portion 14 is formed by connecting the first folding body 1406 and a second folding body 1408. A connection between the first folding body 1406 and the second folding body 1408 is to form a folding region 1409. Form the folding region 1409, the folding body 1406 is bent at a preset support angle toward one direction with respect to the second folding body 1408.

The first folding body 1406 and the second folding body 1408 are formed integrally. The size of the first folding body 1406 corresponding to the thickness of the notebook 2, and the size of the second folding body 1408 match with the first folding body 1406 for support notebook 2 in an appropriate preset support angle. That is, the first folding body 1406 can be regard as the third rigid body 1400 or the first interval section 186 as described aforementioned, and the second folding portion 1408 can be regard as the fourth rigid body 1402 or the second interval section 188. The different is that the first folding body 1406 and the second folding body 1408 are formed integrally. In addition, the material of the first folding body 1406 and the second folding portion 1408 is the metal with support function, such as the metal sheet.

Furthermore, when the state of the notebook 2 from close state to the open state, for the notebook auxiliary device 1, the screen body 20 drives the folding portion 14 corresponding to the mainframe body 22, such that the folding portion 14 is bent under the bottom of the mainframe body 22, and a protrusion is formed by the first folding body 1406 and the second folding body 1408 which are formed integrally to stop between one side of the rotatable pivot 24 of the notebook 2 and the desk (not shown). Similarly, the first folding body 1406 and the second folding body 1408 includes the heat dissipation hole 146, and each heat dissipation hole 146 are arranged with an interval and is opened on one side of the folding body 1406 or one side of the second folding body 1408, and is also formed on one side of the first folding body 1406 and one side of the second folding body 1408 to achieve the increase the heat dissipation effect.

Accordingly, a moveable structure of the conventional prior art is bent from the bending line 1404 (or bending line 184) toward one direction which is omitted in this embodiment, however, the first folding body 1406 and the second folding body 1408 are formed integrally to be a rigid region 140, and the rigid region 140 of the folding portion 14 is bent corresponding to the preset support angle. Thus, the notebook auxiliary device 1 can increase the stability for supporting the notebook 2, and the durable of the notebook auxiliary device 1 can also increase.

Therefore, to compare the present notebook auxiliary device, the notebook auxiliary device can fix on the outside of the notebook by the first rigid body and the second rigid body. When the notebook is at open state, the folding portion of the notebook auxiliary device to lift the notebook to a preset support angle, user can utilize the notebook in a more ergonomic way to reduce fatigue which is introduced by prolonged use of notebook. Because of the preset support angle is disposed between the notebook and the desk, such that the thermal conversion space of the notebook can be increased so that the good heat dissipation effect can be obtained. In addition, because of the notebook auxiliary device of the present invention is disposed on the outside of the notebook such that the user can grip the notebook and is not fallen from the hand of the user, such that notebook auxiliary device can protect the notebook shell and the proportion of goods damaged can also be reduced.

Although specific embodiments have been illustrated and described, it will be obvious to those skilled in the art that various modifications may be made without departing from what is intended to be limited solely by the appended claims.

What is claimed is:

1. A notebook auxiliary device, comprising:
a first rigid body is disposed on a top surface of a screen body of a notebook;
a second rigid body is disposed on a bottom surface of a mainframe body of said notebook; and
a folding portion is disposed between said first rigid body and said second rigid body, said folding portion is driven by said first rigid body to bend under said mainframe body to produce a protrusion so as to form a preset support angle to support said mainframe body.

2. The notebook auxiliary device according to claim 1, wherein said folding portion covered a portion of a rotatable pivot.

3. The notebook auxiliary device according to claim 1, wherein said folding portion comprises:
a rigid region is composed of a third rigid body and a fourth rigid body connected to each other, and a connection portion between said third rigid body and said fourth rigid body is to form a bending line;
a first softness body is connected between said first rigid body and said third rigid body; and
a second softness body is connected between said fourth rigid body and said second rigid body.

4. The notebook auxiliary device according to claim 1, further comprising a first slip resistant, and said first slip resistant is disposed on said first rigid body corresponding to one surface of said screen body.

5. The notebook auxiliary device according to claim 4, further comprising a second slip resistant, and said second slip resistant is disposed on said second rigid body respect to one surface of said mainframe body.

6. The notebook auxiliary device according to claim 1, further comprising a second slip resistant and said second slip resistant is disposed on said second rigid body corresponding to one surface of said mainframe body.

7. The lap top auxiliary device according to claim 1, wherein said first softness body and said second softness body are a hollow recess respectively.

8. The notebook auxiliary device according to claim 3, further comprising at least a heat dissipation hole, and each said heat dissipation hole is disposed on said third rigid body and said fourth rigid body or each said heat dissipation hole is disposed on said third rigid body or said fourth rigid body alternatively.

9. A notebook auxiliary device is composed of a sheet with a three-layers structure, comprising:
a first outer layer;
a support layer is covered on one surface of said outer layer, and said support layer comprises:
a first trench is disposed on one side of said support layer;
a second trench is disposed on another side of said support layer and is parallel to said first trench; and
a bending line is disposed parallel between said first trench and said second trench; and
a second outer layer is covered said support layer respect to another surface of said outer layer.

10. The notebook auxiliary device according to claim 9, wherein a first interval section is disposed between said first trench and said folding line and a second interval section is disposed between said bending line and said second trench, and said first interval section and said second interval section is integrally formed.
